(19) United States
(12) Patent Application Publication
(10) Pub. No.: US 2025/0233214 A1
(43) Pub. Date: Jul. 17, 2025

(54) SOLID-STATE BATTERY, AND PRODUCTION METHOD FOR SOLID-STATE BATTERY

(71) Applicants: TOYOTA JIDOSHA KABUSHIKI KAISHA, Toyota-shi (JP); PANASONIC HOLDINGS CORPORATION, Osaka (JP)

(72) Inventors: Masahiro IWASAKI, Toyota-shi (JP); Heidyhodex VISBALMENDOZA, Toyota-shi (JP); Yusuke ITO, Kashihara-shi (JP); Keita MIZUNO, Ibaraki-shi (JP); Izuru SASAKI, Kyoto-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 19/005,472

(22) Filed: Dec. 30, 2024

(30) Foreign Application Priority Data
Jan. 11, 2024 (JP) 2024-002700

(51) Int. Cl. H01M 10/42; H01M 10/0562; H01M 10/0585

(52) U.S. Cl. CPC H01M 10/4235; H01M 10/0562; H01M 10/0585; H01M 2300/008

(57) ABSTRACT

A solid-state battery includes a positive electrode active material layer, a solid electrolyte layer, and a negative electrode active material layer, in this order, in which: the positive electrode active material layer contains moisture; and the moisture amount of the positive electrode active material layer is 500 ppm to 1200 ppm, the hydroxyl group standard value of the positive electrode active material layer is 0.72 to 0.85, or the moisture amount of the positive electrode active material layer is 500 ppm to 1200 ppm while the hydroxyl group standard value of the positive electrode active material layer is 0.72 to 0.85.

### CROSS-REFERENCE TO RELATED APPLICATION

This application claims priority to Japanese Patent Application No. 2024-002700 filed on Jan. 11, 2024. The disclosure of the above-identified application, including the specification, drawings, and claims, is incorporated by reference herein in its entirety.

### BACKGROUND

### 1. Technical Field

The present disclosure relates to a solid-state battery, and a production method for the solid-state battery.

### 2. Description of Related Art

A solid-state battery is a secondary battery that contains a solid electrolyte as an electrolyte, and has been attracting attention because the solid-state battery has a higher safety than a liquid-state battery in which an electrolytic solution is used as an electrolyte. The solid-state battery has a lower output power than the liquid-state battery. To improve the output power, various developments have been performed. The following electrochemical element containing a solid electrolyte is known.

International Publication No. WO 2018/026009 discloses an electrochemical element including a laminated body that includes a positive electrode, a negative electrode, and a solid electrolyte sandwiched between the positive electrode and the negative electrode. The laminated body contains moisture, and the moisture amount contained in the laminated body is 0.001 mass % or more and is less than 0.3 mass % with respect to the laminated body. With the electrochemical element in International Publication No. WO 2018/026009, the operation can be maintained when high voltage is applied.

### SUMMARY

It is known that the performance of the solid-state battery is improved by uniformly adsorbing a predetermined amount of moisture in an electrode laminated body including the solid electrolyte, as described in International Publication No. WO 2018/026009, for example. However, it is not sufficiently known how an appropriate amount of moisture is adsorbed in a positive electrode active material layer, instead of the whole of the electrode laminated body. Further, a solid-state battery in which the positive electrode active material layer is used, and the performance of the solid-state battery are not sufficiently known.

Hence, the present disclosure has an object to provide a solid-state battery that can restrain resistance increase.

The present disclosure achieves the above object by the following means.

### <Aspect 1>

A solid-state battery comprising a positive electrode active material layer, a solid electrolyte layer, and a negative electrode active material layer, in this order, wherein:
the positive electrode active material layer contains moisture; and
a moisture amount of the positive electrode active material layer is 500 ppm to 1200 ppm, and/or a hydroxyl group standard value of the positive electrode active material layer is 0.72 to 0.85.

### <Aspect 2>

The solid-state battery according to aspect 1, wherein
(i) a moisture amount of the solid electrolyte layer is 300 ppm or less, and a moisture amount of the negative electrode active material layer is 300 ppm or less, and/or
(ii) a hydroxyl group standard value of the solid electrolyte layer is 0.55 or less, and a hydroxyl group standard value of the negative electrode active material layer is 0.37 or less.

### <Aspect 3>

The solid-state battery according to aspect 1 or 2, wherein the solid electrolyte layer contains a sulfide solid electrolyte.

### <Aspect 4>

The solid-state battery according to any one of claims 1 to 3, wherein:
some of the moisture contained in the positive electrode active material layer is physisorbed water that is physically adsorbed in the positive electrode active material layer; and
a moisture amount of the physisorbed water with respect to the moisture amount contained in the positive electrode active material layer is 0.5 to 0.9.

### <Aspect 5>

A production method for the solid-state battery according to any one of aspects 1 to 4, the production method comprising:
adsorbing moisture in the positive electrode active material layer, under an environment of a dew point of 0° C. or lower; and
obtaining the solid-state battery by laminating the positive electrode active material layer in which the moisture is adsorbed, the solid electrolyte layer, and the negative electrode active material layer, in this order.

With the solid-state battery in the present disclosure, it is possible to restrain resistance increase.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a conceptual diagram for describing a solid-state battery in the present disclosure.

### DETAILED DESCRIPTION OF EMBODIMENTS

An embodiment of the present disclosure will be described below in detail. The present disclosure is not limited to the embodiment described below, and can be carried out while being variously modified within the scope of the spirit of the present disclosure. Further, in descriptions with use of the drawing, identical elements are denoted by identical reference numerals, and repetitive descriptions are omitted.

In the present disclosure, a “composite material” means a composition that can compose a positive electrode active material layer or the like just as it is or by further containing another component. Further, in the present disclosure, a “composite material slurry” means a slurry that contains a dispersion medium in addition to the “composite material” and can thereby form the positive electrode active material layer or the like by application and drying.

In the present disclosure, a “solid-state battery” means a battery in which at least a solid electrolyte is used as an electrolyte, and accordingly, in the solid-state battery, a combination of a solid electrolyte and a liquid electrolyte may be used as the electrolyte. Further, the solid-state battery in the present disclosure may be an all-solid-state battery, that is, a battery in which only a solid electrolyte is used as the electrolyte.

### Solid-State Battery

The solid-state battery in the present disclosure includes a positive electrode active material layer, a solid electrolyte layer, and a negative electrode active material layer, in this order, in which:
the positive electrode active material layer contains moisture; and
the moisture amount of the positive electrode active material layer is 500 ppm to 1200 ppm, and/or the hydroxyl group standard value of the positive electrode active material layer is 0.72 to 0.85.

With the solid-state battery in the present disclosure, it is possible to restrain resistance increase.

Although not limited by a theory, it is estimated that a predetermined amount of moisture adsorbed in the positive electrode active material layer penetrates to the interface between the positive electrode active material layer and the solid electrolyte layer, a reaction layer having a moderate thickness is formed at the interface, the reaction layer inhibits the oxidation decomposition of the solid electrolyte at the time of charge, and thereby, it is possible to restrain resistance increase.

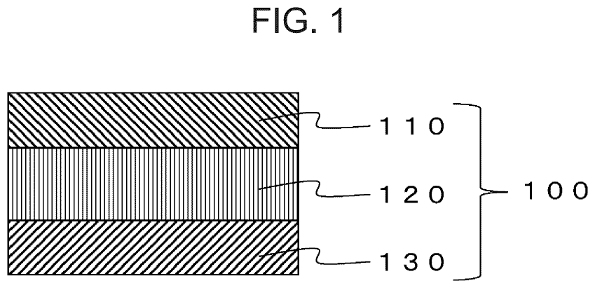

FIG. 1 is a conceptual diagram showing an aspect of the solid-state battery in the present disclosure. The solid-state battery in the present disclosure is not limited to this aspect.

The solid-state battery 100 includes a positive electrode active material layer 110, a solid electrolyte layer 120, and a negative electrode active material layer 130, in this order, and a predetermined amount of moisture is contained in the positive electrode active material layer 110. Due to the predetermined amounts of moisture contained in the positive electrode active material layer 110, it is possible to restrain the resistance increase in the solid-state battery.

### Configuration of Solid-State Battery

The solid-state battery in the present disclosure includes the positive electrode active material layer, the solid electrolyte layer, and the negative electrode active material layer, in this order. The solid-state battery in the present disclosure may optionally include a positive electrode current collector layer and a negative electrode current collector layer, and may include the positive electrode current collector layer, the positive electrode active material layer, the solid electrolyte layer, the negative electrode active material layer, and the negative electrode current collector layer, in this order.

### Positive Electrode Current Collector Layer

The material that is used in the positive electrode active material layer is not particularly limited. A general material for the positive electrode current collector of the solid-state battery can be appropriately employed. Examples of the material that is used in the positive electrode current collector layer include Cu, Ni, Cr, Au, Pt, Ag, Al, Fe, Ti, Zn, Co, and stainless steel, but are not limited to them. Further, the positive electrode current collector layer may include some kind of coat layer on the surface, for example, for adjusting the resistance. Further, the positive electrode current collector layer may be a layer in which one of the above metals is put on a metal foil or a base material by plating or deposition.

The shape of the positive electrode current collector layer is not particularly limited, and can include, for example, a foil shape, a plate shape, and a mesh shape. Among them, the foil shape is preferable.

The thickness of the positive electrode current collector layer is not particularly limited. The thickness of the positive electrode current collector layer may be 0.1 μm or more or 1 μm or more, and may be 1 mm or less or 100 μm or less.

### Positive Electrode Active Material Layer

The positive electrode active material layer contains at least a positive electrode active material and moisture, and further may optionally contain a solid electrolyte, a conduction aid, a binder and others. In addition, the positive electrode active material layer may contain various additive agents. Respective contents of the positive electrode active material, conduction aid, binder and others in the positive electrode active material layer may be appropriately decided depending on an intended battery performance. For example, when the whole (whole solid content) of the positive electrode active material layer is 100 mass %, the content of the positive electrode active material may be 40 mass % or more, 50 mass % or more, or 60 mass % or more, and may be less than 100 mass % or 90 mass % or less.

### Moisture Amount of Positive Electrode Active Material Layer

In the solid-state battery in the present disclosure, the moisture amount of the positive electrode active material layer is 500 ppm to 1200 ppm. The moisture amount of the positive electrode active material layer may be 500 ppm or more, 700 ppm or more, 900 ppm or more, or 1100 ppm or more, from the standpoint of the formation of the reaction layer, and may be 1200 ppm or less, or 1150 ppm or less, from the standpoint of the inhibition of the hydrolysis of the solid electrolyte. The moisture amount of the positive electrode active material layer can be measured using a Karl Fischer device (Karl Fischer device CA-310 and moisture vaporization device VA-300 manufactured by Nittoseiko Co., Ltd.). Specifically, the positive electrode active material layer is heated to 200° C. by the moisture vaporization device VA-300, and the moisture generated by the heating is measured by the Karl Fischer device CA-310, so that the moisture amount can be evaluated.

### Hydroxyl Group Standard Value of Positive Electrode Active Material Layer

In the solid-state battery in the present disclosure, the hydroxyl group standard value of the positive electrode active material layer is 0.72 to 0.85. The hydroxyl group standard value of the positive electrode active material layer may be 0.72 or more, 0.76 or more, 0.80 or more, or 0.83 or more, from the standpoint of the formation of the reaction layer, and may be 0.85 or less, or 0.84 or less, from the standpoint of the inhibition of the hydrolysis of the solid electrolyte. As for the hydroxyl group standard value of the positive electrode active material layer, the absorbance at 3300 cm⁻¹ and the absorbance at 1180 cm⁻¹ for the positive electrode active material layer are measured by Fourier-transform infrared spectroscopy (FT-IR), and the ratio of the absorbance at 3300 cm⁻¹ to the absorbance at 1180 cm⁻¹ can be calculated as the hydroxyl group standard value of the positive electrode active material layer.

Moisture Amount of Physisorbed Water with Respect to Moisture Amount Contained in Positive Electrode Active Material Layer

Although not particularly limited, some of the moisture contained in the positive electrode active material layer may be physisorbed water that is physically adsorbed in the positive electrode active material layer. The moisture amount of the physisorbed water is not particularly limited, and may be 0.50 to 0.90 with respect to the moisture amount contained in the positive electrode active material layer. The moisture amount of the physisorbed water with respect to the moisture amount contained in the positive electrode active material layer may be 0.50 or more, 0.55 or more, 0.60 or more, 0.65 or more, or 0.70 or more, and may be 0.90 or less, 0.85 or less, 0.80 or less, or 0.75 or less. The moisture amount of the physisorbed water with respect to the moisture amount contained in the positive electrode active material layer can be evaluated from a generation rate curve for water (m/z=18) that is obtained by performing the measurement at measurement temperatures of 30° C. to 500° C. at a temperature increase rate of 10° C./min by heating-generated gas mass spectrometry (TPD-MS). Specifically, as the moisture amount of the physisorbed water, the moisture amount that is generated when the temperature is increased to 100° C. is calculated from a peak area in the generation rate curve for water at measurement temperatures of 30° C. to 100° C. Next, as the moisture amount contained in the positive electrode active material layer, the moisture amount that is generated when the temperature is increased to 120° C. is calculated from a peak area in the generation rate curve for water at measurement temperatures of 30° C. to 120° C. Then, from the respective calculated moisture amounts, the moisture amount of the physisorbed water with respect to the moisture amount contained in the positive electrode active material layer can be calculated and evaluated.

### Positive Electrode Active Material

The material of the positive electrode active material is not particularly limited, as long as lithium ions can be stored and released. Examples of the positive electrode active material include lithium cobalt oxide (LiCoO₂), lithium nickel oxide (LiNiO₂), lithium manganese oxide (LiMn₂O₄), lithium nickel-cobalt-manganese oxide (NCM: LiCo_{1/3}Ni_{1/3}Mn_{1/3}O₂), lithium nickel-cobalt-aluminum oxide (LiNi_{0.8}(CoAl)_{0.2}O₂), a different—element substitution Li—Mn spinel having a composition expressed as Li₁₊ₓMn_{2-x-y}M_{y}O₄ (M is one or more kinds of metal elements selected from Al, Mg, Co, Fe, Ni, and Zn), but are not limited to them.

Although not particularly limited, the positive electrode active material may include a covering layer. The covering layer is a layer containing a substance that has a lithium-ion conductibility, that has a low reactivity with the positive electrode active material or the solid electrolyte, and that does not flow and can maintain the form of the covering layer even when the substance makes contact with the active material or the solid electrolyte. Specific examples of the material that composes the covering layer include LiNbO₃, Li₄Ti₅O₁₂, Li₃PO₄, and Li—Ti—Al—F materials, but are not limited to them.

The form of the positive electrode active material is not particularly limited, as long as a general form for the positive electrode active material of the solid-state battery is adopted. For example, the positive electrode active material may have a particle form. The positive electrode active material may have a primary particle, or may have a secondary particle in which a plurality of primary particles is aggregated. For example, an average particle diameter D₅₀ of the positive electrode active material may be 1 nm or more, 5 nm or more, or 10 nm or more, and may be 500 μm or less, 100 μm or less, 50 μm or less, or 30 μm or less. The average particle diameter D₅₀ is a particle diameter (median diameter) at an integrated value of 50% in a volume-basis particle size distribution that is evaluated by a laser diffracting/scattering method.

### Solid Electrolyte

The material of the solid electrolyte is not particularly limited, and for example, may be a sulfide solid electrolyte, an oxide solid electrolyte, a polymer electrolyte, or the like.

Examples of the sulfide solid electrolyte include a sulfide amorphous solid electrolyte, a sulfide crystalline solid electrolyte, and an argyrodite solid electrolyte, but are not limited to them. Specific examples of the sulfide solid electrolyte include Li₂S—P₂S₅ (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, LinoGeP₂S₁₂, or the like), LiI—Li₂S—P₂O₅, LiI—Li₃PO₄—P₂S₅, Li₂₋ₓPS₆₋ₓClₓ, and a combination of them, but are not limited to them.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ (PO₄)₃, Li₁₊ₓAlₓGe₂₋ₓ(PO₄)₃, Li₃PO₄, and Li₃₊ₓPO₄₋ₓNₓ(LiPON), but are not limited to them.

The sulfide solid electrolyte and the oxide solid electrolyte may be glass, or may be crystallized glass (glass ceramics).

Examples of the polymer electrolyte include polyethylene oxide (PEO), polypropylene oxide (PPO), and a copolymer of polyethylene oxide and polypropylene oxide, but are not limited to them.

### Conduction Aid

The conduction aid is not particularly limited. Examples of the conduction aid include vapor-grown carbon fiber (VGCF), acetylene black (AB), Ketjen black (KB), carbon nanotube (CNT), carbon nanofiber (CNF), and conductive carbon, but are not limited to them. The conduction aid may have a particle form or a fiber form, for example, and the size of the particle or fiber is not particularly limited. Although not particularly limited, as the conduction aid, only one kind may be used, or two or more kinds may be combined and used.

### Binder

The binder is not particularly limited. The binder may be composed of a material such polyvinylidene fluoride (PVdF), butadiene rubber (BR), polytetrafluoroethylene (PTFE), and styrene-butadiene rubber (SBR), for example, but is not limited to them. Although not particularly limited, as the binder, only one kind may be used, or two or more kinds may be combined and used.

The shape of the positive electrode active material layer is not particularly limited, and for example, a sheet-shaped positive electrode active material layer having a roughly flat surface may be adopted. The thickness of the positive electrode active material layer is not particularly limited. For example, the thickness of the positive electrode active material layer may be 0.1 μm or more, 1 μm or more, or 10 μm or more, and may be 2 mm or less, 1 mm or less, or 500 μm or less.

The positive electrode active material layer can be produced by applying a known method. The positive electrode active material layer can be easily shaped, for example, by the dry or wet shaping of a positive electrode composite material containing the above various components. The positive electrode active material layer may be shaped together with the positive electrode current collector layer, or may be shaped separately from the positive electrode current collector layer.

### Solid Electrolyte Layer

The solid electrolyte layer contains at least a solid electrolyte, and may contain a conduction aid, a binder, and the like, as necessary. The solid electrolyte layer is not particularly limited, and preferably should contain a sulfide solid electrolyte.

### Moisture Amount of Solid Electrolyte Layer

The moisture amount of the solid electrolyte layer is not particularly limited, and may be 300 ppm or less. Further, the moisture amount of the solid electrolyte layer may be 0 ppm or more, 1 ppm or more, 10 ppm or more, 50 ppm or more, or 100 ppm or more, and may be 300 ppm or less, 280 ppm or less, 260 ppm or less, or 240 ppm or less. As for the measurement of the moisture amount of the solid electrolyte layer, the above description in “Moisture Amount of Positive Electrode Active Material Layer” can be referred to.

### Hydroxyl Group Standard Value of Solid Electrolyte Layer

The hydroxyl group standard value of the solid electrolyte layer is not particularly limited, and may be 0.55 or less. Further, the hydroxyl group standard value of the solid electrolyte layer may be 0.460 or more, 0.461 or more, 0.470 or more, 0.480 or more, or 0.500 or more, and may be 0.550 or less, 0.543 or less, 0.537 or less, or 0.530 or less. As for the measurement of the hydroxyl group standard value of the solid electrolyte layer, the above description in “Hydroxyl Group Standard Value of Positive Electrode Active Material Layer” can be referred to.

As for the solid electrolyte, the conduction aid, and the binder, the above description in “Positive Electrode Active Material Layer” can be referred to.

The thickness of the solid electrolyte layer is not particularly limited. For example, the thickness of the solid electrolyte layer may be 0.1 μm or more, 1 μm or more, or 10 μm or more, and may be 2 mm or less, 1 mm or less, or 500 μm or less.

The solid electrolyte layer can be easily formed, for example, by the dry or wet shaping of a solid electrolyte composite material containing the above solid electrolyte, binder, and others.

### Negative Electrode Active Material Layer

The negative electrode active material layer contains at least a negative electrode active material, and further may optionally contain a conduction aid, a binder, a solid electrolyte, and others. In addition, the negative electrode active material layer may contain various additive agents. Respective contents of the negative electrode active material, conduction aid, binder, solid electrolyte, and others in the negative electrode active material layer may be appropriately decided depending on an intended battery performance. For example, when the whole (whole solid content) of the negative electrode active material layer is 100 mass %, the content of the negative electrode active material may be 40 mass % or more, 50 mass % or more, or 60 mass % or more, and may be 100 mass % or less or 90 mass % or less.

### Moisture Amount of Negative Electrode Active Material Layer

The moisture amount of the negative electrode active material layer is not particularly limited, and may be 300 ppm or less. Further, the moisture amount of the negative electrode active material layer may be 150 ppm or more, 160 ppm or more, 170 ppm or more, 180 ppm or more, 190 ppm or more, or 200 ppm or more, and may be 300 ppm or less, 280 ppm or less, 260 ppm or less, 240 ppm or less, or 220 ppm or less. As for the measurement of the moisture amount of the negative electrode active material layer, the above description in “Moisture Amount of Positive Electrode Active Material Layer” can be referred to.

### Hydroxyl Group Standard Value of Negative Electrode Active Material Layer

The hydroxyl group standard value of the negative electrode active material layer is not particularly limited, and may be 0.37 or less. Further, the hydroxyl group standard value of the negative electrode active material layer may be 0.01 or more, 0.02 or more, 0.04 or more, 0.06 or more, or 0.08 or more, and may be 0.37 or less, 0.31 or less, 0.25 or less, 0.19 or less, or 0.13 or less. As for the measurement of the hydroxyl group standard value of the negative electrode active material layer, the above description in “Hydroxyl Group Standard Value of Positive Electrode Active Material Layer” can be referred to.

### Negative Electrode Active Material

As the negative electrode active material, various substances in which an electric potential (charge and discharge potential) at which lithium ions are stored and released is a base potential compared to the above positive electrode active material in the present disclosure can be employed. The material of the negative electrode active material is not particularly limited, and may be metal lithium, or may be a material that can store and release metal ions such as lithium ions. Examples of the material that can store and release metal ions such as lithium ions include alloy system negative electrode active materials, carbon materials, and lithium titanate (Li₄Ti₅O₁₂), but are not limited to them.

The alloy system negative electrode active material is not particularly limited, and examples of the alloy system negative electrode active material include a Si alloy system negative electrode active material and a Sn alloy system negative electrode active material. Examples of the Si alloy system negative electrode active material include silicon, silicon oxide, silicon carbide, silicon nitride, and solid solutions of them. Further, the Si alloy system negative electrode active material may contain a metal element other than silicon, and for example, may contain Fe, Co, Sb, Bi, Pb, Ni, Cu, Zn, Ge, In, Sn, Ti, or the like. Examples of the Sn alloy system negative electrode active material include tin, tin oxide, tin nitride, and solid solutions of them. Further, the Sn alloy system negative electrode active material may contain a metal element other than tin, and for example, may contain Fe, Co, Sb, Bi, Pb, Ni, Cu, Zn, Ge, In, Ti, Si, or the like.

The carbon material is not particularly limited, and examples of the carbon material include hard carbon, soft carbon, and graphite.

The form of the negative electrode active material is not particularly limited, and a general form for the negative electrode active material of the solid-state battery may be adopted. For example, the negative electrode active material may have a particle form, or may have a sheet form.

As for the solid electrolyte, conduction aid, and binder that can be contained in the negative electrode active material layer, the above description in “Positive Electrode Active Material Layer” can be referred to.

The shape of the negative electrode active material layer is not particularly limited, and for example, a sheet-shaped negative electrode active material layer having a roughly flat surface may be adopted. The thickness of the negative electrode active material layer is not particularly limited. For example, the thickness of the negative electrode active material layer may be 0.1 μm or more, 1 μm or more, or 10 μm or more, and may be 2 mm or less, 1 mm or less, or 500 μm or less.

The negative electrode active material layer can be produced by applying a known method. The negative electrode active material layer can be easily shaped, for example, by the dry or wet shaping of a negative electrode composite material containing the above various components. The negative electrode active material layer may be shaped together with the negative electrode current collector layer, or may be shaped separately from the negative electrode current collector layer.

### Negative Electrode Current Collector Layer

The material that is used in the negative electrode current collector layer is not particularly limited. A general material for the negative electrode current collector of the solid-state battery can be appropriately employed. Examples of the material that is used in the negative electrode current collector layer include Cu, Ni, Cr, Au, Pt, Ag, Al, Fe, Ti, Zn, Co, stainless steel, and carbon sheet, but are not limited to them. The negative electrode current collector layer may include a coat layer on the surface, for example, for adjusting the resistance.

The shape of the negative electrode current collector layer is not particularly limited, and can include, for example, a foil shape, a plate shape, and a mesh shape. Among them, the foil shape is preferable.

The thickness of the negative electrode current collector layer is not particularly limited. The thickness of the negative electrode current collector layer may be 0.1 μm or more or 1 μm or more, and may be 1 mm or less or 100 μm or less.

### Shape and Others of Solid-State Battery

Examples of the shape of the solid-state battery include a coin type, a laminate type, a cylinder type, and a square type, but are not limited to them.

### Production Method for Solid-State Battery

The solid-state battery in the present disclosure can be produced by a production method including the following steps:
adsorbing moisture in the positive electrode active material layer, under an environment of a dew point of 0° C. or lower; and
obtaining the solid-state battery by laminating the positive electrode active material layer in which the moisture is adsorbed, the solid electrolyte layer, and the negative electrode active material layer, in this order.

With the production method for the solid-state battery in the present disclosure, it is possible to produce a solid-state battery that can restrain resistance increase.

### Moisture Adsorbing Method

As a method for adsorbing moisture in the positive electrode active material layer, for example, moisture can be adsorbed by placing the positive electrode active material layer for a predetermined time in a glove box or the like in which the humidity is adjusted at a dew point of −60° C., but the method for adsorbing moisture in the positive electrode active material layer is not limited to this.

From the standpoint of the inhibition of the change in the structure of the solid electrolyte, the dew point in an environment in which moisture is attached to the positive electrode active material layer may be 0° C. or lower, −10° C. or lower, −30° C. or lower, or −50° C. or lower, and may be −80° C. or higher, −75° C. or higher, −70° C. or higher, or −65° C. or higher.

The time for which moisture is attached to the positive electrode active material layer is not particularly limited. The time for which moisture is attached to the positive electrode active material layer may be 1 second or more, 10 seconds or more, 30 seconds or more, 1 minute or more, 10 minutes or more, 30 minutes or more, or 1 hour or more, and may be 5 hours or less, 3 hours or less, 1 hour or less, or 30 minutes or less.

### Laminating Method

As a method for laminating the positive electrode active material layer, the solid electrolyte layer, and the negative electrode active material layer, specifically, for example, solid electrolyte layers formed on base materials are overlapped and pressed on respective surfaces of negative electrode active material layers formed on both surfaces of a negative electrode current collector, the solid electrolyte layers are transferred to the surfaces of the negative electrode active material layers, and the base materials that contact with the solid electrolyte layers are removed, so that the solid electrolyte layers are laminated on the negative electrode active material layers. Next, positive electrode active material layers formed on base materials are overlapped and pressed on respective surfaces of the solid electrolyte layers laminated on both surfaces of the negative electrode active material layers, the positive electrode active material layers are transferred to the surfaces of the solid electrolyte layers, and the base materials that contacts with the positive electrode active material layers are removed, so that the positive electrode active material layers are laminated on the solid electrolyte layers. However, the method for laminating the positive electrode active material layer, the solid electrolyte layer, and the negative electrode active material layer is not limited to this.

The above laminated body may be adopted as the solid-state battery. Alternatively, the laminated body in which the positive electrode active material layer, the solid electrolyte layer, and the negative electrode active material layer are laminated may be provided with the positive electrode current collector layer and/or the negative electrode current collector layer as necessary, may be enclosed by a laminate film, and may be adopted as the solid-state battery. Although nor particularly limited, the solid-state battery may be confined, for example, at a confined pressure of 5 MPa.

The present disclosure will be described in more detail with reference to the following examples. The scope of the present disclosure is not limited to the examples.

Moisture Amounts of Positive Electrode Active Material Layer, Solid Electrolyte Layer, Negative Electrode Active Material Layer, and Densified Laminated Body

The moisture amounts of the above respective layers and the above laminated body were measured using the Karl Fischer device (Karl Fischer device CA-310 and moisture vaporization device VA-300 manufactured by Nittoseiko Co., Ltd.). Specifically, a measurement sample was heated to 200° C. by the moisture vaporization device VA-300, and the moisture generated by the heating was measured by the Karl Fischer device CA-310, so that the moisture amount was evaluated.

### Hydroxyl Group Standard Value of Positive Electrode Active Material Layer

As for the hydroxyl group standard value of the positive electrode active material layer, the absorbance at 3300 cm⁻¹ and the absorbance at 1180 cm⁻¹ for the positive electrode active material layer were measured by Fourier-transform infrared spectroscopy (FT-IR), and the ratio of the absorbance at 3300 cm⁻¹ to the absorbance at 1180 cm⁻¹ was calculated as the hydroxyl group standard value of the positive electrode active material layer.

### Example 1

### Production of Positive Electrode Active Material Layer A1

LiNi_{0.8} (CoAl)_{0.2}O₂ coated with a Li—Ti—Al—F material as a positive electrode active material, Li₂S—P₂S₅ glass ceramics as a solid electrolyte, conductive carbon as a conduction aid, a binder, a dispersion agent, and a moderate amount of solvent were mixed, and dispersion process was performed by an ultrasonic homogenizer, so that a positive electrode composite material slurry was prepared. Next, an aluminum foil was coated with the obtained positive electrode composite material slurry by die coating, and was dried, so that a positive electrode active material layer was formed on one surface of the aluminum foil. The obtained positive electrode active material layer was placed for a predetermined time in a humidity-adjustment glove box in which the dew point was set to −60° C., so that a positive electrode active material layer A1 in which moisture was adsorbed was obtained. The moisture amount of the positive electrode active material layer A1 was 576 ppm, and the hydroxyl group standard value was 0.73.

### Production of Solid Electrolyte Layer B1

LiI—LiBr—Li₂S—P₂S₅ glass ceramics (average particle diameter: 2.5 μm) as a solid electrolyte, conductive carbon as a conduction aid, a binder, a dispersion agent, and a moderate amount of solvent were mixed, and dispersion process was performed by an ultrasonic homogenizer, so that a solid electrolyte composite material slurry was prepared. Next, an aluminum foil was coated with the obtained solid electrolyte composite material slurry by die coating, and was dried, so that a solid electrolyte layer B1 was formed on one side of the aluminum foil. The solid electrolyte layer B1 was not placed in a humidity-adjustment glove box in which the dew point was set to −60° C., and the intentional moisture adsorption was not performed. The moisture amount of the solid electrolyte layer B1 was 235 ppm, and the hydroxyl group standard value was 0.53.

### Production of Negative Electrode Active Material Layer C1

Li₄Ti₅O₁₂ particles as a negative electrode active material, Li₂S—P₂S₅ glass ceramics as a solid electrolyte, conductive carbon as a conduction aid, a binder, a dispersion agent, and a moderate amount of solvent were mixed, and dispersion process was performed by an ultrasonic homogenizer, so that a negative electrode composite material slurry was prepared. Next, an aluminum foil as a negative electrode current collector was coated with the obtained negative electrode composite material slurry by die coating, and was dried, so that a negative electrode active material layer was formed on one surface of the aluminum foil. Thereafter, a surface of the aluminum foil on which the negative electrode active material layer was not formed was coated with the negative electrode composite material slurry by die coating, and was dried, so that negative electrode active material layers C1 were formed on both surfaces of the aluminum foil. The negative electrode active material layer C1 was not placed in a humidity-adjustment glove box in which the dew point was set to −60° C., and the intentional moisture adsorption was not performed. The moisture amount of the negative electrode active material layer C1 was 205 ppm, and the hydroxyl group standard value was 0.10. The base weight of the negative electrode active material layer was adjusted such that the charge specific capacity of the negative electrode active material layer was one time the charge specific capacity of the positive electrode active material layer when the charge specific capacity of the positive electrode active material layer was 200 mAh/g.

### Production of Densified Laminated Body D1

Solid electrolyte layers B1 were overlapped and pressed on respective surfaces of the negative electrode active material layers C1 formed on both surfaces of the aluminum foil as the negative electrode current collector, the solid electrolyte layers B1 were transferred to the surfaces of the negative electrode active material layers C1, and the aluminum foils that contacted with the solid electrolyte layers B1 were removed, so that the solid electrolyte layers B1 were laminated on the negative electrode active material layers C1. Next, positive electrode active material layers A1 were overlapped and pressed on respective surfaces of the solid electrolyte layers B1 laminated on both surfaces of the negative electrode active material layers C1, the positive electrode active material layers A1 were transferred to the surfaces of the solid electrolyte layers B1, and the aluminum foils that contacted with the positive electrode active material layers A1 were removed, so that the positive electrode active material layers A1 were laminated on the solid electrolyte layers B1. Roll press was performed to the produced laminated body at 175° C. at 5 ton/cm, so that a densified laminated body D1 was produced.

### Production of Solid-State Battery E1

Carbon-coated aluminum foils as positive electrode current collectors were disposed on respective surfaces of the positive electrode active material layers A1 of the densified laminated body D1, and were pressed at 140° C. at 5 MPa for 5 minutes, so that an electricity generating element was obtained. In the electricity generating element, the positive electrode current collector layer, the positive electrode active material layer A1, the solid electrolyte layer B1, the negative electrode active material layer C1, the negative electrode current collector layer, the negative electrode active material layer C1, the solid electrolyte layer B1, the positive electrode active material layer A1, and the positive electrode current collector layer were laminated in this order. The obtained electricity generating element was enclosed by a laminate film, and was confined at 5 MPa, so that a solid-state battery E1 was produced.

### Resistance Increase Rate of Solid-State Battery E1

To the solid-state battery E1, constant-current charge was performed at about 0.3 C until the voltage reached a voltage equivalent to a charge level of 40%, and next, constant-voltage charge was performed until the electric current reached an electric current of 0.01 C. Thereafter, the solid-state battery E1 was disposed in a constant-temperature bath in which the temperature was set to 60° C., and was preserved for two weeks. The direct-current resistance was measured before and after the preservation in the constant-temperature bath. The difference between the value of the direct-current resistance after the preservation and the value of the direct-current resistance before the preservation was divided by the value of the direct-current resistance before the preservation, and was multiplied by 100, so that the resistance increase rate (%) between before and after the preservation was calculated (the resistance increase rate (%)=(the direct-current resistance (Ω) after the preservation—the direct-current resistance (Ω) before the preservation)/(the direct-current resistance (Ω) before the preservation)×100). The resistance increase rate of the solid-state battery E1 was −1.26%. The value of the direct-current resistance was calculated as follows. Constant-current discharge was performed at about 72 C, to the solid-state battery E1 after the constant-current charge was performed at about 0.3 C until the voltage reached a voltage equivalent to a charge level of 40% and next the constant-voltage charge was performed until the electric current reached an electric current of 0.01 C, and the difference between the voltage before the discharge and the voltage after the discharge for 0.1 seconds is divided by an electric current amount equivalent to 72 C (the direct-current resistance ((2)=(the voltage (V) before the discharge—the voltage (V) after the discharge for 0.1 seconds)/the electric current amount (A) equivalent to 72 C).

### Example 2

### Production of Positive Electrode Active Material Layer A2

A positive electrode active material layer was formed by the same method as Example 1, and the obtained positive electrode active material layer was placed for a predetermined time in a humidity-adjustment glove box in which the dew point was set to −60° C., so that a positive electrode active material layer A2 in which moisture was adsorbed was obtained. The moisture amount and hydroxyl group standard value of the positive electrode active material layer A2 are shown in Table 1.

### Production of Solid-State Battery E2, and Resistance Increase Rate of Solid-State Battery E2

A solid-state battery E2 was produced by the same method as Example 1, except that the positive electrode active material layer A2 was used instead of the positive electrode active material layer A1. Further, the resistance increase rate of the solid-state battery E2 was evaluated by the same method as Example 1. The resistance increase rate of the solid-state battery E2 is shown in Table 1.

### Example 3

### Production of Positive Electrode Active Material Layer A3

A positive electrode active material layer was formed by the same method as Example 1, and the obtained positive electrode active material layer was placed for a predetermined time in a humidity-adjustment glove box in which the dew point was set to −60° C., so that a positive electrode active material layer A3 in which moisture was adsorbed was obtained. The moisture amount and hydroxyl group standard value of the positive electrode active material layer A3 are shown in Table 1.

### Production of Solid-State Battery E3, and Resistance Increase Rate of Solid-State Battery E3

A solid-state battery E3 was produced by the same method as Example 1, except that the positive electrode active material layer A3 was used instead of the positive electrode active material layer A1. Further, the resistance increase rate of the solid-state battery E3 was evaluated by the same method as Example 1. The resistance increase rate of the solid-state battery E3 is shown in Table 1.

### Comparative Example 1

### Production of Positive Electrode Active Material Layer A4

A positive electrode active material layer was formed by the same method as Example 1, and the obtained positive electrode active material layer was placed for a predetermined time in a humidity-adjustment glove box in which the dew point was set to −60° C., so that a positive electrode active material layer A4 in which moisture was adsorbed was obtained. The moisture amount and hydroxyl group standard value of the positive electrode active material layer A4 are shown in Table 1.

Production of Solid-State Battery e1, and Resistance Increase Rate of Solid-State Battery e1

A solid-state battery e1 was produced by the same method as Example 1, except that the positive electrode active material layer A4 was used instead of the positive electrode active material layer A1. Further, the resistance increase rate of the solid-state battery e1 was evaluated by the same method as Example 1. The resistance increase rate of the solid-state battery e1 is shown in Table 1.

### Comparative Example 2

### Production of Positive Electrode Active Material Layer A5

A positive electrode active material layer was formed by the same method as Example 1, and the obtained positive electrode active material layer was placed for 15 minutes in a humidity-adjustment glove box in which the dew point was set to −60° C., so that a positive electrode active material layer A5 in which moisture was adsorbed was obtained. The moisture amount and hydroxyl group standard value of the positive electrode active material layer A5 are shown in Table 1.

### Production of Solid Electrolyte Layer B2

A solid electrolyte layer was formed by the same method as Example 1, and the obtained solid electrolyte layer was placed for 15 minutes in a humidity-adjustment glove box in which the dew point was set to −60° C., so that a solid electrolyte layer B2 in which moisture was adsorbed was obtained. The moisture amount and hydroxyl group standard value of the solid electrolyte layer B2 are shown in Table 1.

### Production of Negative Electrode Active Material Layer C2

A negative electrode active material layer was formed by the same method as Example 1, and the obtained negative electrode active material layer was placed for 15 minutes in a humidity-adjustment glove box in which the dew point was set to −60° C., so that a negative electrode active material layer C2 in which moisture was adsorbed was obtained. The moisture amount and hydroxyl group standard value of the negative electrode active material layer C2 are shown in Table 1.

### Production of Solid-State Battery e2, and Resistance Increase Rate of Solid-State Battery e2

A solid-state battery e2 was produced by the same method as Example 1, except that the positive electrode active material layer A5 was used instead of the positive electrode active material layer A1, the solid electrolyte layer B2 was used instead of the solid electrolyte layer B1, and the negative electrode active material layer C2 was used instead of the negative electrode active material layer C1. Further, the resistance increase rate of the solid-state battery e2 was evaluated by the same method as Example 1. The resistance increase rate of the solid-state battery e2 is shown in Table 1.

### Comparative Example 3

### Production of Positive Electrode Active Material Layer A6

A positive electrode active material layer A6 was formed on the surface of an aluminum foil by the same method as Example 1. The positive electrode active material layer A6 was not placed in a humidity-adjustment glove box in which the dew point was set to −60° C., and the intentional moisture adsorption was not performed.

### Production of Densified Laminated Body d3

A densified laminated body was produced by the same method as Example 1, except that the positive electrode active material layer A6 was used instead of the positive electrode active material layer A1. The obtained densified laminated body was placed for 15 minutes in a humidity-adjustment glove box in which the dew point was set to −60° C., so that a densified laminated body d3 in which moisture was adsorbed was obtained. The moisture amount of the densified laminated body d3 is shown in Table 1.

### Production of Solid-State Battery e3, and Resistance Increase Rate of Solid-State Battery e3

A solid-state battery e3 was produced by the same method as Example 1, except that the densified laminated body d3 was used instead of the densified laminated body D1. Further, the resistance increase rate of the solid-state battery e3 was evaluated by the same method as Example 1. The resistance increase rate of the solid-state battery e3 is shown in Table 1.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Moisture adsorption object | | Positive | Positive | Positive | Positive | Positive | Densified laminated |
| | | electrode | electrode | electrode | electrode | electrode | body |
| | | active material | active material | active material | active material | active material | |
| | | layer | layer | layer | layer | layer | |
| | | | | | | Solid | |
| | | | | | | electrolyte | |
| | | | | | | layer | |
| | | | | | | Negative | |
| | | | | | | electrode | |
| | | | | | | active material | |
| | | | | | | layer | |
| Positive electrode active | | Positive | Positive | Positive | Positive | Positive | Layer constitution |
| material layer | | electrode | electrode | electrode | electrode | electrode | Positive electrode |
| | | active material | active material | active material | active material | active material | active material layer |
| | | layer A1 | layer A2 | layer A3 | layer A4 | layer A5 | A6 |
| Adsorption | Dew point [° C.] | −60 | −60 | −60 | −60 | −60 | Solid electrolyte layer |
| condition | | | | | | | B1 |
| Analysis | Moisture amount [ppm] | 576 | 836 | 1143 | 328 | 377 | Negative electrode |
| value | Hydroxyl group | 0.73 | 0.78 | 0.84 | 0.69 | 0.7 | active material |
| | standard value [—] | | | | | | layer C1 |
| Solid electrolyte layer | | Solid | Solid | Solid | Solid | Solid | Moisture adsorption |
| | | electrolyte | electrolyte | electrolyte | electrolyte | electrolyte | condition |
| | | layer B1 | layer B1 | layer B1 | layer B1 | layer B2 | The same as |
| Analysis | Moisture amount [ppm] | 235 | 235 | 235 | 235 | 396 | Comparative Example |
| value | Hydroxyl group | 0.53 | 0.53 | 0.53 | 0.53 | 0.58 | 2 |
| | standard value [—] | | | | | | Moisture amount of |
| Negative electrode active | | Negative | Negative | Negative | Negative | Negative | densified laminated body |
| material layer | | electrode | electrode | electrode | electrode | electrode | d3 |
| | | active material | active material | active material | active material | active material | 167 ppm |
| | | layer C1 | layer C1 | layer C1 | layer C1 | layer C2 | |
| Analysis | Moisture amount [ppm] | 205 | 205 | 205 | 205 | 381 | |
| value | Hydroxyl group | 0.10 | 0.10 | 0.10 | 0.10 | 0.58 | |
| | standard value [—] | | | | | | |
| Total of moisture amounts | | 1016 | 1276 | 1583 | 768 | 1154 | |
| of layers [ppm] | | | | | | | |
| Solid-state battery | | Solid-state | Solid-state | Solid-state | Solid-state | Solid-state | Solid-state |
| | | battery E1 | battery E2 | battery E3 | battery e1 | battery e2 | battery e3 |
| Evaluation | Resistance increase rate | −1.26 | −1.71 | −2.68 | −0.14 | −0.51 | −0.39 |
| result | [%] | | | | | | |

### Example 4

### Production of Positive Electrode Active Material Layer A7

A positive electrode active material layer A7 was produced by the same method as Example 1, except that the positive electrode active material layer A7 was disposed in a humidity-adjustment glove box in which the dew point was set to −60° C., and was placed for 60 minutes.

### Ratio of Physisorbed Water to Moisture Contained in Positive Electrode Active Material Layer A7

The measurement of the positive electrode active material layer A7 was performed at measurement temperatures of 30° C. to 500° C. at a temperature increase rate of 10° C./min by heating-generated gas mass spectrometry (TPD-MS), so that a generation rate curve for water (m/z=18) was evaluated. Next, as the moisture amount of physisorbed water, the moisture amount that was generated when the temperature was increased to 100° C. was calculated from a peak area in the generation rate curve for water at measurement temperatures of 30° C. to 100° C. Similarly, as the moisture amount contained in the positive electrode active material layer, the moisture amount that was generated when the temperature was increased to 120° C. was calculated from a peak area in the generation rate curve for water at measurement temperatures of 30° C. to 120° C. The ratio of the moisture amount of the physisorbed water to the moisture amount contained in the positive electrode active material layer A7 was 0.70.

### Example 5

Production of Positive Electrode Active Material Layer A8, and Ratio of Physisorbed Water to Moisture Contained in Positive Electrode Active Material Layer A8

A positive electrode active material layer A8 was produced by the same method as Example 1, except that the positive electrode active material layer A8 was disposed in a humidity-adjustment glove box in which the dew point was set to −50° C., and was placed for 60 minutes. The ratio of the physisorbed water to the moisture amount contained in the positive electrode active material layer A8 was evaluated by the same method as Example 4. The measurement result is shown in Table 2.

TABLE 2

| | | Example 4 | Example 5 |
|---|---|---|---|
| Moisture adsorption object | | Positive | Positive |
| | | electrode | electrode |
| | | active material | active material |
| Positive electrode active | | Positive | Positive |
| material layer | | electrode | electrode |
| | | active material | active material |
| | | layer A7 | layer A8 |
| Adsorption | Dew point [° C.] | −60 | −50 |
| condition | Time [min] | 60 | 60 |
| TPD-MS | Moisture generation | 1060 | 2243 |
| | amount until 100° C. | | |
| | [ppm] | | |
| | Moisture generation | 1507 | 3023 |
| | amount until 120° C. | | |
| | [ppm] | | |
| | Ratio of physisorbed | 0.70 | 0.74 |
| | water [—] | | |

In Examples 1 to 3 and Comparative Example 1, a predetermined amount of moisture was adsorbed in the positive electrode active material layer, the solid-state battery was produced using the positive electrode active material layer, and the resistance increase rate was evaluated. On the other hand, in Comparative Example 2, moisture was uniformly adsorbed in the positive electrode active material layer, the solid electrolyte layer, and the negative electrode active material layer, under the same condition, the solid-state battery was produced using the positive electrode active material layer, the solid electrolyte layer, and the negative electrode active material layer, and the resistance increase rate was evaluated. Further, in Comparative Example 3, moisture was uniformly adsorbed in the densified laminated body, the solid-state battery was produced using the densified laminated body, and the resistance increase rate was evaluated.

From Examples 1 to 3 and Comparative Example 1, it was confirmed that it was possible to restrain the resistance increase in the solid-state battery in which the positive electrode active material layer containing a predetermined amount or more of moisture was used. Further, from Examples 1 to 3 and Comparative Examples 2 and 3, it is was confirmed that it was possible to restrain the resistance increase in the obtained solid-state battery when a predetermined amount of moisture was adsorbed in the positive electrode active material layer, compared to when moisture was uniformly adsorbed in all layers or the laminated body under the same condition. It was confirmed that there were large differences in resistance increase rate among Examples 1 and 2 and Comparative Example 2 even though equivalent values were shown as the total of the moisture amounts of the layers.

In each of Examples 4 and 5, the moisture adsorbed in the positive electrode active material layer was analyzed. It was confirmed that the moisture amount of the physisorbed water in the positive electrode active material layer with respect to the moisture amount contained in the positive electrode active material layer was 0.5 to 0.9, that is, a large amount of physisorbed water was contained in the positive electrode active material layer, when moisture was adsorbed in the positive electrode active material layer under an environment of a low dew point (a dew point of −60° C. or −50° C.).

Although details are unclear, it is estimated that a predetermined amount of moisture adsorbed in the positive electrode active material layer, particularly, a large amount of physisorbed water contained in the positive electrode active material layer penetrated to the interface between the positive electrode active material layer and the solid electrolyte layer, a reaction layer having a moderate thickness was formed at the interface, the reaction layer inhibited the oxidation decomposition of the solid electrolyte at the time of charge, and thereby, it was possible to restrain the resistance increase.

Preferred embodiments of the solid-state battery in the present disclosure and the production method for the solid-state battery have been described. However, a person skilled in the art understands that modifications can be made without departing from the scope of the claims.

What is claimed is:

1. A solid-state battery comprising a positive electrode active material layer, a solid electrolyte layer, and a negative electrode active material layer, in this order, wherein:
the positive electrode active material layer contains moisture; and
a moisture amount of the positive electrode active material layer is 500 ppm to 1200 ppm, and/or a hydroxyl group standard value of the positive electrode active material layer is 0.72 to 0.85.

2. The solid-state battery according to claim 1, wherein
(i) a moisture amount of the solid electrolyte layer is 300 ppm or less, and a moisture amount of the negative electrode active material layer is 300 ppm or less, and/or
(ii) a hydroxyl group standard value of the solid electrolyte layer is 0.55 or less, and a hydroxyl group standard value of the negative electrode active material layer is 0.37 or less.

3. The solid-state battery according to claim 1, wherein the solid electrolyte layer contains a sulfide solid electrolyte.

4. The solid-state battery according to claim 1, wherein:
some of the moisture contained in the positive electrode active material layer is physisorbed water that is physically adsorbed in the positive electrode active material layer; and
a moisture amount of the physisorbed water with respect to the moisture amount contained in the positive electrode active material layer is 0.50 to 0.90.

5. A production method for the solid-state battery according to claim 1, the production method comprising:
adsorbing moisture in the positive electrode active material layer, under an environment of a dew point of 0° C. or lower; and
obtaining the solid-state battery by laminating the positive electrode active material layer in which the moisture is adsorbed, the solid electrolyte layer, and the negative electrode active material layer, in this order.
